(19) United States
(12) Patent Application Publication
(10) Pub. No.: US 2003/0043984 A1
(43) Pub. Date: Mar. 6, 2003

(54) Prepaid telephone service with automatic number identification recognition

(75) Inventor: Jeffrey P. Lauzon, West Bloomfield, MI (US)

Correspondence Address: Kevin J. Heinl, Brooks & Kushman P.C., 22nd Floor, 1000 Town Center, Southfield, MI, 48075-1351, US

(73) Assignee: Telecents Communications, Inc., Walled Lake, MI

(21) Appl. No.: 10/194,575

(22) Filed: Jul. 12, 2002

Related U.S. Application Data
(60) Provisional application No. 60/304,991, filed on Jul. 12, 2001.

(51) Int. Cl. H04M 15/00; H04M 17/00

(52) U.S. Cl. 379/144.01; 379/114.15; 379/114.16; 379/114.2

(57) ABSTRACT

A prepaid telephone calling card service that uses ANI recognition of a telephone used to register an account for preauthorization of subsequent calls from the same telephone. The calling cards are purchased through retain stores and then registered with a service provider. Additional ANIs may be associated with the account for preauthorization of subsequent calls. Registration of the account is completed by a consumer following a series of voice prompts without the need for authorization or intervention by the company administering the prepaid calling card service.

### BACKGROUND OF THE INVENTION

1. Field of the Invention

The present invention relates to a prepaid telephone service that uses automatic number identification (ANI) recognition to obviate the need to enter a personal identification number when a call is placed from a telephone having an ANI. An account is setup after the calling card is purchased by following a voice prompt guided registration procedure.

2. Background Art

Telephone calling cards are commonly used to permit long distance and local telephone calls to be paid for on a prepaid basis. One disadvantage of prepaid calling cards is the need to enter the personal identification number each time a call is placed. Some systems offer a continuous calling feature that permits the PIN number to be entered once to make one call and then permits further calls to be made provided that the phone is prompted with a “#” or “*” prior to hanging up the telephone. The broad acceptance of prepaid telephone calling cards have resulted in customers using them for attractive low rates and to place calls from home, work or other numbers on a regular basis.

Many employers restrict employees use of the employers' telephone system but will permit employees to use the telephone system provided that they pay for the telephone calls. In such situations, prepaid telephone calling cards provide a way for employees to place personal calls without their employers incurring charges for such calls. Similarly, employer policies regarding the use of online systems may be more tolerant of employees who use prepaid telephone calling cards for access charges.

These and other problems and disadvantages associated with prior art prepaid telephone calling cards are addressed by the present invention as summarized below.

### SUMMARY OF THE INVENTION

According to the present invention, an improved, easier to use prepaid calling card is provided that utilizes a self initializing computer based registration procedure following purchase of the card from a retail store. The customer can register a predetermined number of telephone numbers (“ANI”) that are enabled for dialing without using a personal identification number (“PIN”). With a speed dial enabled phone a purchaser of a calling card of the present invention can use the card by simply speed dialing a toll free number (“TFN”), upon recognizing the ANI of the telephone used to call the TFN the system provides a dial tone and the customer can then dial the desired number normally.

According to one aspect of the present invention, a method for providing prepaid calling card service that provides for preauthorization without repeatedly entering an access code is provided. According to the method, a calling card package is provided that has a set of instructions for initiating a set up procedure. The calling card package is sold to consumers. The set up procedure is initiated by a consumer dialing the TFN of a communication facility. The communication facility captures an ANI number of a telephone associated with the consumer. The communication facility interacts with the consumer to set up an account wherein the ANI of the telephone associated with the consumer is recorded as part of the account information. In subsequent calls, the communication facility recognizes the ANI number associated with the consumer and provides a dial tone signal thereby enabling the consumer to make a prepaid call without entering an identification number or authorization code.

According to other aspects of the invention, the prepaid calling card service may include providing a voice mail box, three-way calling, or internet connection capability. The service may also permit a plurality of ANI numbers to be associated with the consumer and credited to the consumer's account. The system is also flexible in that it permits a consumer to access their account from a dial-up location that is not an ANI associated with the consumer by entering the ANI associated with the consumer and a security code. The system preferably provides instructions for initiating a set up procedure and further includes a toll free set up number and account number. The toll free set up number may be dialed to initiate a procedure for recharging an account balance by paying for additional phone service credit.

According to another aspect of the invention, a method for registering a prepaid calling card service is provided. The method includes purchasing a calling card package having instructions for initiating a set up procedure. A call processing system is accessed by dialing a toll free set up number included in the calling card package to initiate the set up procedure from a telephone having an ANI associated with the telephone. Information requested by the call processing system is provided by the consumer to set up an account. The call processing system learns the ANI which becomes a recognized ANI for future preauthorized, personal identification number-free dialing.

According to other aspects of the method for registering a prepaid calling card service, may include entering a set up access number and registering at least two ANIs that are associated with the consumer account in allowing preauthorized personal identification number-free telephone service. A security code may be entered to allow the consumer to access the account from a dial up location that is not a recognized ANI.

According to another aspect of the invention, a system for setting up an account for a prepaid calling card service is provided that includes a calling card package having a set of instructions, contact information, and an account number. A trunk group is accessible from a dial up location by following the set of instructions to route a call through a carrier to a communication facility. A call processing system at the communication facility captures the ANI of the dial up location and queries the consumer to guide a consumer through a set up procedure to create an account for the consumer. An advantage of the system is that a customer can utilize the system to setup their account without the need for authorization or intervention on the part of the company administering the prepaid calling card service. The ANI of the dial up location functions as an authorization code that does not require manual entry after the call processing system has captured the ANI of the dial up location.

According to further aspects of the invention, the call processing system may comprise an interactive voice response unit that is programmed to interact with a consumer and a call processing server. The call processing server is programmed to manage information routed to and from the interactive voice response unit and a database system for storing and processing account information. The database system is accessible by the call processing server.

Other features and advantages of the present invention will be readily understood in view of the attached drawings and detailed description.

### BRIEF DESCRIPTION OF THE DRAWINGS

FIGS. 1a and 1b are two parts of a flowchart illustrating the account set-up steps followed by the system; and

FIG. 2 is a diagram of an exemplary network showing an expanded application of one embodiment of the invention.

### DETAILED DESCRIPTION OF THE PREFERRED EMBODIMENTS

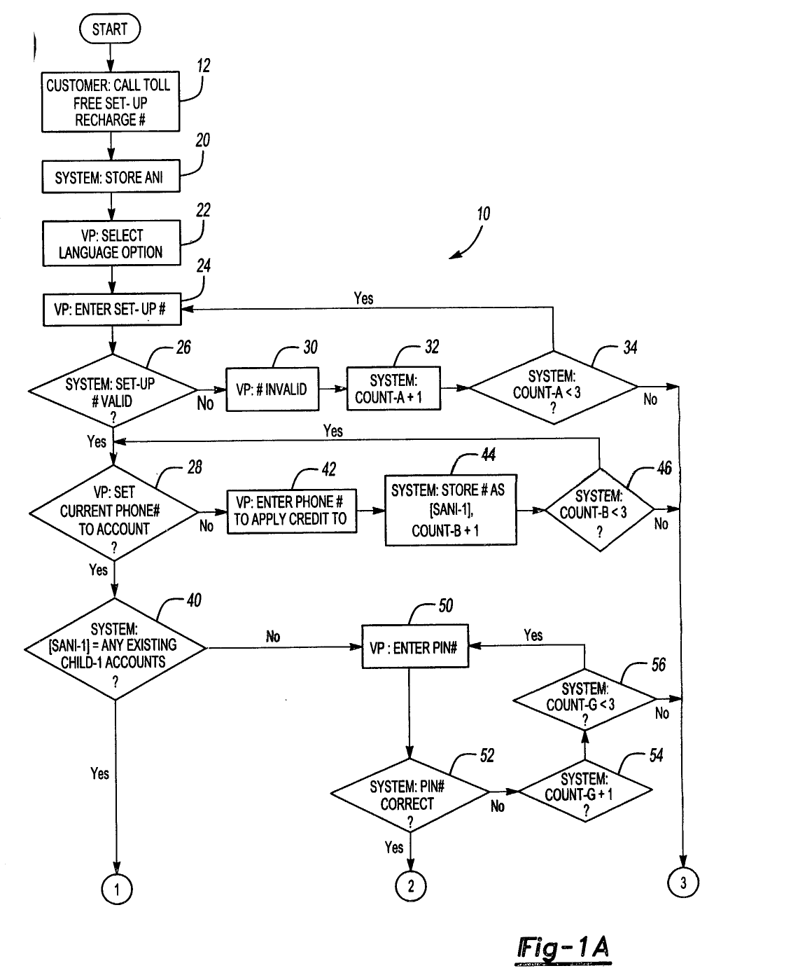

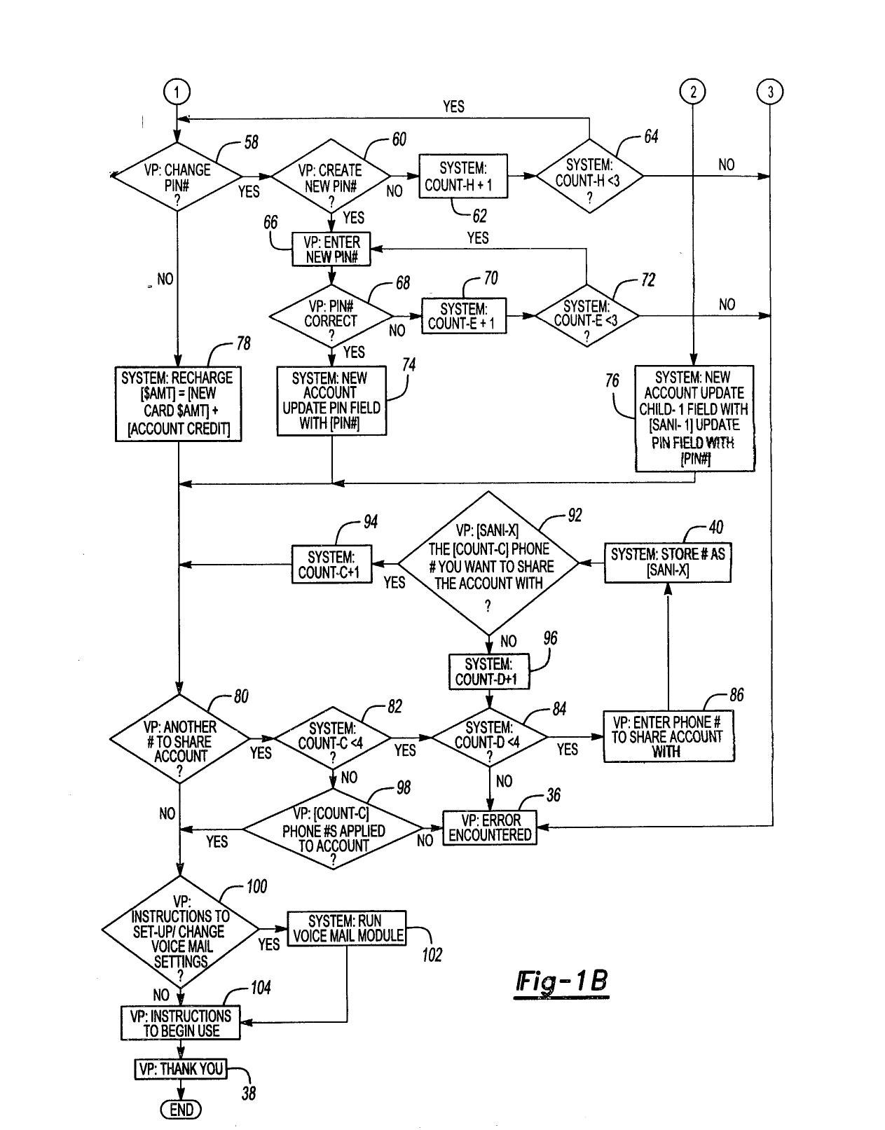

According to the present invention a customer may purchase a prepaid dial around service calling card from a retail location. The system for setting up an account is illustrated by FIGS. 1a and 1b and is generally referred to by reference numeral 10.

FIGS. 1a and 1b illustrate the steps of the process for setting up a prepaid home account with three numbers. The flowchart also illustrates how a customer can recharge the account balance by paying for additional telephone credit. The procedural steps for setting up an account and recharging an account by following representative voice mail prompts is also shown.

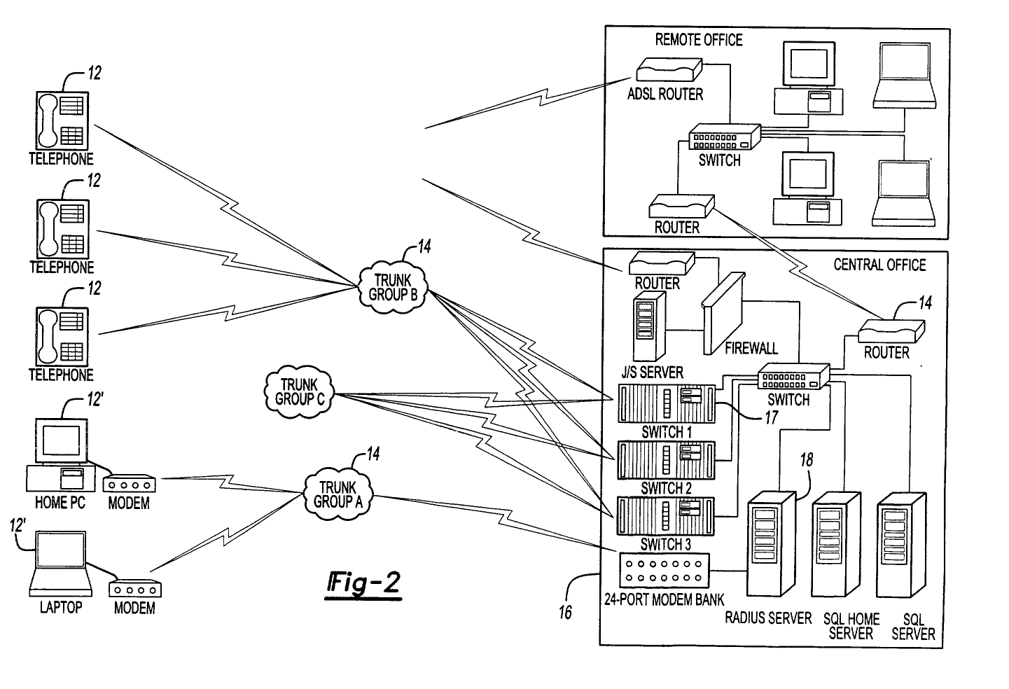

Referring to FIG. 2, an expanded network diagram is provided to illustrate a network having voice 12 and modem 12′ access over trunk groups 14. A communication facility 16 that has switches 17, servers 18, and routers 19 is also shown. The calling card includes a toll-free number (TFN) that may be called by the customer from their home or from another location. The toll-free number is referred as “TFN#1” and is identified by reference numeral 12. Referring now to FIG. 2, TFN#1 is pointed to a Trunk Group 14 with a Tier-1 carrier from within the continental United States. Once the customer dials TFN#1, the phone call is routed to a communication facility, that administers the system. The call is received by a call processing server 18 that captures all of or a portion of TFN#1. After the system captures TFN#1 it initializes a specialized module for setting up the home prepaid dial around service.

The expanded network is illustrated by FIG. 2 that illustrates the general configuration of the network. FIG. 2 illustrates a system when three toll-free numbers are available one for setup/recharge, DNIS and ANI capture. A second toll-free number is used to place calls and retrieve voice mail and also includes DNIS and ANI capture. A third toll-free number is used for calling collect or leaving voice mail and also includes DNIS and ANI capture. The system also envisions use of either a home PC or a laptop PC communicating via modem to a modem bank in the call processing center.

Referring back to FIG. 1a, After the customer calls the toll free set-up number, the system at 20 stores the ANI of the telephone used by the customer to call the toll-free number. The customer upon entering the call processing server responds to voice prompts that permit the selection of the language for dialog at 22. The system also requests entry of a ten digit account set-up number that may be found on the calling card at 24. The account number is then checked for validity at 26. If the account number is valid the customer is queried regarding his home phone or the system at 28 may automatically capture the ANI of the phone placing the call to TFN#1. If the account number is invalid, a voice prompt is generated by the system at 30 and the system increments a counter A at 32 that limits the number of set up numbers that may be checked at 34 to a predetermined number of attempts, for example 3 attempts. If the number of attempts is less than 3, the customer is again prompted to enter a set up number at 24. If the account is exceeded, an error message is provided by the voice prompt at 36 and the system terminates the transaction by thanking the consumer at 38.

If the set up number is valid, and after the voice prompt is given regarding setting the current phone number to the account at 28, the system at 40 queries as to whether an additional charge account should be set up. If the voice prompt at 28 is responded to in the negative, a further voice prompt will be generated requesting that the customer enter the phone number that the credit is to be applied to at 42. The system then stores the number at 44 as SANI-1 as counter B is incremented. If the counter B at 46 is less than a predetermined number, for example less than 3, the system returns to 28 and inquiries as to setting up an additional phone number to the account. If the count at 46 is greater than the predetermined number, the system generates the error message at 36 and signs off with a thank you at 38.

The system then checks if the SANI-1 is equal to any of the Child-1 accounts at 40. If not, a voice prompt is provided to the customer to enter their PIN number at 50. The system then checks to determine if the PIN number is correct at 52. If the PIN number is determined to be incorrect at 52, the system increments a counter G at 54. The system then may determine at 56 if the count is less than a predetermined number, for example 3, if so, the system provides the voice prompt to enter the PIN number at 50 as previously described. If the count G is 3 or more, the system generates an error voice prompt at 36 and a thank you voice prompt at 38.

Referring now to FIG. 1b, if the system determines that the SANI-1 is equal to an existing Child-1 account, the system then inquires at 58 as to whether the consumer wishes to change their PIN number. If so, a voice prompt is issued at 60. If the voice prompt regarding creating a new PIN number is answered negatively, the system at 62 increments counter H. If counter H is less than a predetermined number, for example 3, the system will loop back and inquire by a voice prompt as to changing the PIN number at 58. If the count is 3 or more, the system generates a voice prompt regarding the error at 36 and thanks the consumer at 38. If an affirmative response is generated at 60 as to creating a new PIN number a new PIN number is created at 66. The system confirms the PIN number at 68 by asking for the customer to repeat the PIN number entered at 66. If the PIN number is incorrect, upon second entry, the system increments a counter E at 70 which is then checked at 72 to determine whether counter E has exceeded a predetermined number, for example 3. If counter E is less than 3, the voice prompt at 66 is regenerated requesting that the new PIN number be entered. If counter E is greater than the predetermined number, an error message is generated at 36 and the consumer is thanked by the voice prompt at 38.

If the PIN number is correct, then the system permits the account to be updated to include the new PIN number at 74.

If the system determines that the PIN number is correct at 52, the system then proceeds to update the Child-1 field with a SANI-1 update field with the new PIN number at 76.

If the voice prompt inquiring into changing the PIN number is answered negatively at 58, the system then proceeds to recharge the credit amount $AMT which is stated to be equal to the new card $AMT plus the account credit balance at 78. The system then inquires at 80 by voice prompt as to whether another account number is to be permitted to share the account. If the ANI of the phone used to call the TFN#1 is the customer's home and is one of the numbers that the customer intends to use without entering a PIN number this number is entered into the database. The customer is permitted to add additional numbers that are also enabled without a personal identification number. In general, one to three numbers are anticipated to be enabled for personal identification number free dialing. If the customer indicates affirmatively that another number should be added to share the account, the system checks at 82 to determine whether or not the count at counter C that counts the number of phone numbers sharing the account is less than a predetermined number, for example 4. If it is less than 4, the system determines whether or not the counter D is less than 4. Counter D is a counter for rejected confirmation phone numbers. If counter D at 84 is less than 4, the system generates a voice prompt at 86 requesting entry of the phone number for sharing the account. The system stores that number at SANI-X, at 90. A voice prompt at 92 repeats SANI-X indicating that it is the first, second, or third phone number that is to share the account and requests confirmation. If confirmed, the system increments the counter C by one at 94 and returns to the voice prompt at 80. If the customer does not confirm that SANI-X is the first, second, or third phone number to share the account, the system increments the counter D at 96 that limits the number of erroneous ANI entries that may be made when setting up the system.

After all of the SANI-X numbers are entered that are permitted by the system, the system drops down to 100 wherein a voice prompt is provided to set up or change voice mail settings. If it is desired to set up or change voice mail settings, the system will run a voice mail module at 102. The system also provides for a voice mail account that may be setup by using a second toll-free number “TFN#2.” When the customer dials TFN#2 the call is again routed to a communication facility having a call processing server. When the communication facility recognizes that TFN#2 has been dialed the system attempts to recognize the ANI from the telephone call received.

After the voice mail module has been run at 102 or if the prompt regarding instructions to set up or change voice mail settings is declined, the system issues a voice prompt providing instructions for beginning use of the system at 104. Following instructions to begin use at 104, the system thanks the consumer at 38.

The system also automatically provides account balance information. If the ANI is one of the authorized personal identification free numbers the system will provide a voice prompt preferably indicating the balance available on the calling card. The system then provides dial tone if the ANI is recognized and the user may then dial the phone number that they intend to call. If the ANI is not recognized a different voice prompt is provided requesting that the caller enter their account number. The service is intended to be portable meaning that a consumer may use their home phone number and a security code as their account and password just like they would with other prepaid calling cards. The ability to use the prepaid calling card from certain telephone numbers without entering a personal identification number or security code permits customers to use a prepaid calling card as easily as direct dialing especially if the customer has a speed dialing capability that can allow the toll-free number to be dialed on a one touch basis. The account number will be the first number setup for personal identification number free dialing which in most instances will the customer's home or office number. If a different phone is used the home number is entered with a security code since the customer is not calling from one of the authorized numbers. Upon successful entry of the number and security code the balance in the account is then announced.

If a new voice mail message has been received an additional prompt may be displayed after the account balance prompt by stating “you have new voice mail.” After the voice mail identification is given the phone immediately provides a dial tone for entry of a number. If instead of proceeding with a phone call the person wishes to check their voice mail they may dial a special key or series of numbers and access their voice mail directly.

Another feature of the invention is to provide three-way calling using prepaid per minute billing. Any of the preauthorized personal identification number free numbers will be able to initiate a three-way call.

The voice mail feature of the invention is intended to be based upon the user's home or office phone number. The user's home or office phone number will also be the mailbox number for the voice mail system.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method for providing a prepaid calling card service provides for preauthorization without repeatedly entering an access code, comprising:
providing a calling card package having a set of instructions for initiating a setup procedure;
selling the calling card package to the consumer;
receiving a telephone call from the consumer dialing a communication facility to initiate the setup procedure;
capturing an ANI number of a telephone associated with the consumer;
interacting with the consumer to set up an account wherein the ANI of the telephone associated with the consumer is recorded as part of the account;
recognizing the ANI number associated with the consumer; and
providing a dial tone signal enabling the consumer to make a prepaid call.

2. The method of providing a prepaid calling card service of claim 1 wherein the service further includes a voice mailbox.

3. The method of providing a prepaid calling card service of claim 1 wherein the service further includes 3-way calling.

4. The method of providing a prepaid calling card service of claim 1 wherein the service further includes internet connection capabilities.

5. The method of providing a prepaid calling service of claim 1 wherein the service allows a plurality of ANI numbers to be associated with the consumer and credited to the same account.

6. The method of providing a prepaid calling service of claim 1 wherein the service allows the consumer to access the account from a dial-up location that is not an ANI associated with the consumer by entering the ANI associated with the consumer and a security code.

7. The method of providing a prepaid calling card service of claim 1 wherein the set of instructions for initiating a setup procedure further includes a toll-free setup number and an account number.

8. The method of providing a prepaid calling card service of claim 7 wherein the toll-free setup number may be dialed to initiate a procedure for recharging an account balance by paying for additional phone credit.

9. A method for registering for a prepaid calling card service; comprising:
purchasing a calling card package having instructions for initiating a setup procedure;
accessing a call processing system by dialing a toll-free setup number included in the calling card package to initiate the setup procedure from a telephone having an ANI associated with the telephone;
providing the information requested by the call processing system to set up an account; and
wherein the call processing system learns the ANI as a recognized ANI for future preauthorized, personal identification number-free dialing.

10. The method for registering for a prepaid calling card service of claim 9 wherein providing the information further includes entering a setup access number and registering at least two ANIs that are associated with the consumer account and allow preauthorized, personal identification number-free telephone service.

11. The method for registering for a prepaid calling card service of claim 9 wherein providing the information further includes entering a security code to allow the consumer to access the account from a dial-up location that is not a recognized ANI.

12. A system for a prepaid calling card service, comprising:
a calling card package having a set of instructions, contact information and an account number for initiating a setup procedure;
a trunk group accessible from a dial-up location by following the set of instructions to route a call through a carrier to a communication facility,
a call processing system at the communication facility that captures the ANI of the dial-up location, the call processing system queries the consumer through the set up procedure to create an account for the consumer; and
wherein the ANI of the dial-up location functions as an authorization code that does not require manual entry after the call processing system has captured the ANI of the dial up location.

13. The system for a prepaid calling card service of claim 10, wherein the call processing system further comprises:
an interactive voice response unit programmed to interact with a consumer and a call processing server;
the call processing server programmed to manage information routed to and from the interactive voice response unit and a database system for storing and processing account information, the database system being accessible by the call processing server.
